(19) United States
(12) Patent Application Publication
(10) Pub. No.: US 2018/0174706 A1
(43) Pub. Date: Jun. 21, 2018

(54) TWO-CORE BALANCED CABLE

(71) Applicant: JUNKOSHA INC., Ibaraki (JP)

(72) Inventors: Katsuo SHIMOSAWA, Ibaraki (JP); Yuu MATSUBARA, Ibaraki (JP)

(73) Assignee: JUNKOSHA INC., Ibaraki (JP)

(21) Appl. No.: 15/551,986

(22) PCT Filed: Feb. 4, 2016
(86) PCT No.: PCT/JP2016/053354

§ 371 Date: Dec. 22, 2017

(30) Foreign Application Priority Data
Feb. 20, 2015 (JP) 2015-032360

(51) Int. Cl. H01B 7/04; H01B 11/02; H01B 7/02; H01B 7/18; H01B 3/44

(52) U.S. Cl. CPC H01B 7/04; H01B 11/02; H01B 3/445; H01B 7/18; H01B 7/0225

(57) ABSTRACT

(Problem) Provided is a twisted pair cable that has moderate flexibility and uniformity in bending with respect to a bending direction.

(Solution) A twisted pair cable (10) includes a double-twisted core line (28) formed by twisting two core lines (26) having conductors (22) and dielectric layers (24) formed on outer circumferences thereof, an inclusion (30) formed of polytetrafluoroethylene and twisted and combined with the double-twisted core line (28), a winding body layer (32) wound on an outer circumference of the core lines (26) and the inclusion (30), an outer conductor (34) installed on an outer circumference of the winding body layer (32), and an outer coating (36) installed on an outer circumference of the outer conductor (34) and has ellipticity of an overall cross-sectional shape of the cable formed to be within a range of 2% to 8%.

### TECHNICAL FIELD

The present invention relates to a twisted pair cable, and more particularly, to a cable adequate for high speed differential transmission.

### BACKGROUND ART

Generally, an image test for determining whether a product is accepted in a line of a semiconductor manufacturing plant and the like has been performed by adequately bending a gauged rod body that accommodates a differential transmission cable with a camera attached thereto to slide forward and backward or leftward and rightward to consecutively taking an image of each product. Recently, due to an improvement in performance of camera, the above-described differential transmission cable performs a high speed transmission bit rate (for example, full configuration-595 Mbps) but needs a gauged cable and an improvement in life of the cable with respect to the sliding.

As a first conventional example of the differential transmission cable, there is known a twisted pair cable including insulation lines formed by coating outer circumferences of center conductors with insulation layers, a single lateral lay shield formed by laterally winding a wire on an outer circumference of the two insulation lines once, a metal tape body formed by spirally winding copper foil tape on an outer circumference of the single lateral lay shield, and an outer coating that covers an outer circumference of the metal tape body (refer to Patent document 1).

Also, as a second conventional example, there is known a twisted pair cable having a relatively circular cross-sectional structure by combining an inclusion with a twisted pair line and installing a lateral lay shield on an outer circumference thereof (refer to Patent document 2).

Also, as another conventional example, there is known a so-called quad cable formed by rightward or leftward twisting four signal lines with dielectric layers on outer circumferences of inner conductors by twisting a plurality of conductor lines and forming an outer conductor and an outer coating on outside thereof.

### PRIOR ART DOCUMENT

[Patent Document]

(Patent document 1) Japanese Patent Publication No. 2009-164039

(Patent document 2) Japanese Patent Publication No. 2007-26736

### DISCLOSURE OF INVENTION

### Technical Problem

As described above, since a cable used in an image test and the like at a line in a manufacturing plant needs to perform image tests of a large number of products and is repeatedly bent and slid, needs for a cable life adequate for the bending and sliding and flexibility that allows the winding and sliding have increased.

However, there is a difficulty in a mechanical property of the twisted pair cable according to the above-described first conventional example. That is, since two insulation-coated conductors are arranged in parallel and an outer conductor or an outer coating is directly disposed on an outer circumference thereof, the twisted pair cable according to the first conventional example has an elliptical cross section due to a structure thereof. Since there are present a direction to easily bend and a direction difficult to bend due to this, a deviation in bending property that depends on a bending direction is formed. When a double-twisted core line is laterally disposed, the core lines remain in a state of being easily bent without mutual interference when being vertically bent but remain in a state of being bent with difficulty by mutually interfering to form a difference between an inner ring and an outer ring and to increase a reaction of a core line positioned closer to the inner ring while being laterally bent. Accordingly, the deviation in bending property occurs. As described above, there was a problem in which mechanical properties are deteriorated because it is easy to be distorted by a stress caused by the bending direction and a deviation in bending property occurs due to the bending direction. Accordingly, there is unstability in life of a cable with respect to the sliding repeated more than several thousand times.

Meanwhile, since the above-described cable according to the second conventional example has the relatively circular cross-sectional structure by combining the twisted pair line with the inclusion but the lateral lay shield is directly wound on the twisted pair line and the inclusion, there are critical problems in which a deformation caused by a compression force of the lateral lay shield is not uniform due to a difference in flexibilities of the twisted pair line and the inclusion and it is initially difficult to maintain an original shape of a cross-sectional shape. Also, even when the lateral lay shield is formed, not only there is no structure that maintains a laterally wound structure thereof from outside but also it is apprehended that the lateral lay shield is scattered and the cross-sectional shape does not remain because the twisted pair line and the inclusion pressurize the lateral lay shield on the line due to repeated bending or sliding. Also, since rayon yarn having a relatively high elongation rate is applied as the inclusion to the cable, when a plurality of times of bending and sliding are performed, not only the inclusion elongates and does not function as a tension member of the cable but also the elongated inclusion pushes another component upward to form wrinkles overall on the cable. Also, since a gap is easily generated between laterally wound widths and an electromagnetic field is radiated through the gap when the lateral lay shield is scattered as described above, it is apprehended that electrical shield properties may be deteriorated.

Also, in the above-described quad cable, since the four signal lines are twisted and combined in such a way that a cross-sectional shape of the outer conductor disposed around the signal lines is approximately circular, a bending property is excellent in any direction. Accordingly, there is no problem in bending uniformity from the first. Also, since one pair of signal lines among the four signal lines are arranged close to another pair of signal lines, shielding between signal lines is not adequate and cross talks occur. Accordingly, it is apprehended that signal intensity and signal quality are deteriorated in such a way that electrical properties are deteriorated.

From the above description, to allow a cable to be strong on being bent and to increase a life of the cable, it is necessary to develop a cable having compatible uniformity in bending and flexibility of the cable.

The present invention is provided in consideration of the above-described problems and an aspect thereof is to provide a twisted pair cable that reconciles uniformity in bending and flexibility of the cable to allow the cable to be strong on bending and to increase a life of the cable with respect to sliding.

The inventor, as a result of studying a cable structure capable of improving mechanical properties in comparison with a conventional twisted pair cable while having high electrical properties obtained by a twisted pair cable, has worked out a cable having the same configuration of a twisted pair cable as a basic configuration, including an inclusion formed of polytetrafluoroethylene and a winding body layer, formed to be in a structurally circular cross section with ellipticity of an overall cross-sectional shape of the cable within a range of 2% to 8%, and capable of effectively preventing the occurrence of a deviation in bending property caused by a bending direction due to upward and downward or leftward and rightward symmetry and additionally having adequate flexibility to increase mechanical properties such as being strong on bending, a cable life with respect to sliding and the like.

### Technical Solution

According to an aspect of the present invention, a twisted pair cable includes a double-twisted core line formed by twisting two core lines having conductors and dielectric layers formed on outer circumferences thereof, an inclusion formed of polytetrafluoroethylene and twisted and combined with the double-twisted core line, a winding body layer wound on an outer circumference of the core lines and the inclusion, an outer conductor installed on an outer circumference of the winding body layer, and an outer coating installed on an outer circumference of the outer conductor and has ellipticity of an overall cross-sectional shape of the cable in an initial state formed to be within a range of 2% to 8%. Here, [symbol] polytetrafluoroethylene [symbol] includes both a porous type and a nonporous type. Also, the initial state refers to a following state of sliding 30 times not a state of a new product and [symbol] ellipticity (%) [symbol] is obtained by ((maximum value of diameter of outer conductor−minimum value of diameter of outer conductor)/(maximum value of diameter of outer conductor)×100).

According to the above configuration, the twisted pair cable having adequate flexibility and adequate bending properties in any directions may be configured.

Also, a length of a width between crests of unevenness of a waveform of a surface shape in a longitudinal direction of the outer coating may be 15 times to 50 times of a diameter of the core line. Here, [symbol] the width between crests of unevenness [symbol] corresponds to a width between crests of unevenness of a surface in a longitudinal direction of the cable. According to the configuration, adequate flexibility in the longitudinal direction of the cable may be provided by adjusting an adhesive force between the core lines and the inclusion and additionally a more flexible cable may be embodied by applying the features of the present invention to a part that needs bending properties. Accordingly, a twisted pair cable that has adequate flexibility and uniformity in bending with respect to a bending direction may be provided.

According to another aspect of the present invention, a twisted pair cable includes a double-twisted core line formed by twisting two core lines having conductors and dielectric layers formed on outer circumferences thereof, an inclusion formed of polytetrafluoroethylene and twisted and combined with the double-twisted core line, a winding body layer wound on an outer circumference of the core lines and the inclusion, an outer conductor installed on an outer circumference of the winding body layer, and an outer coating installed on an outer circumference of the outer conductor. Here, ellipticity of an overall cross-sectional shape of the cable in a state after a predetermined sliding test is formed to be within a range of 2% to 10%. Here, [symbol] the predetermined sliding test [symbol] refers to a test performed in predetermined sliding conditions (the number of sliding is ten thousand times, bending R is 10 mm, a sliding velocity is 100 times/min, and a length of sliding stroke is 200 mm) using a following sliding tester.

That is, it is necessary to pay attention to a change of ellipticity caused by the occurrence of distortion or deformation at core lines, an outer conductor, a winding body layer and the like that are components before and after the sliding test. Due to the configuration, the present invention provides excellent mechanical properties such as a cable life with respect to sliding which are absolutely not obtained by conventional examples, for a long time. According to the above, a twisted pair cable that has adequate flexibility and uniformity in bending with respect to a bending direction for a long time may be provided.

### BRIEF DESCRIPTION OF DRAWINGS

FIG. 1 is a schematic cross-sectional view illustrating twisted pair cables according to first to fourth embodiments of the present invention and a comparative example 1.

FIG. 2(a) is a schematic diagram illustrating a twisted state of pair-twisted core wires according to the embodiment of the present invention, and FIG. 2(b) is a schematic diagram illustrating an uneven configuration of a waveform of a surface shape in a longitudinal direction of an outer cover of the twisted pair cable according to the embodiment of the present invention.

FIG. 3 is a schematic diagram of a sliding test apparatus.

FIG. 4 is a schematic cross-sectional view illustrating a twisted pair cable according to a comparative example 2.

### BEST MODE FOR INVENTION

Hereafter, embodiments and comparative examples of the present invention will be described with reference to the drawings. Following embodiments and comparative examples specify a range in which uniformity in bending and flexibility of a twisted pair cable according to the present invention are compatible with each other.

First, as ellipticity of the twisted pair cable increases, the uniformity of bending decreases in comparison to a case in which the ellipticity is 0%. When the uniformity of bending decreases, a distance between an internal conductor and an external conductor becomes irregular in a longitudinal direction of a cable only by repeatedly slight sliding or bending. As a result thereof, since fluctuation in distance from a center of an inner conductor to an outer conductor in a longitudinal direction of a cable increases in a twin core structure formed by twisting and combining two core lines, characteristic impedance is scattered and reflection waves increase in such a way that an attenuation rate that indicates how much degree an input signal is reduced at an output place (hereinafter, referred to as the attenuation rate) increases. As a result thereof, the attenuation rate of the cable exceeds 10 dB at a frequency of 900 MHz generally used for a camera link cable and deterioration of electrical properties is shown. Due to this, in the present invention, an upper limit of ellipticity is 8%.

With respect to this, it is considerable to further decrease the ellipticity to be closer to 0% but there is a problem in an aspect of flexibility. That is, since flexibility is deteriorated by intensively winding a winding body layer and an outer conductor and accordingly an excessive compression force is applied, for example, even in an initial state of slightly sliding, it may be apprehended that an inner conductor and a dielectric that form a core line are destructed and damaged and a standard deviation of characteristic impedance greatly exceeds 3Ω in such a way that electrical properties are deteriorated. Due to this, in the present invention, a lower limit of ellipticity is 2%. That is, in the present invention, to obtain compatible uniformity in bending and flexibility, the overall cross-sectional shape of the cable is set to be within a range of 2 to 8%.

Also, in the present invention, a winding body layer is disposed between a core line and an outer conductor in such a way that the outer conductor and the winding body layer surround the core line and an inclusion and ellipticity formed by the core line and the inclusion is controlled with higher precision than that of an initial state. Also, since positions of the core line and the outer conductor that form the cable are mutually shifted by a bend after the cable slides, the core line pushes upward and pressurizes the outer conductor in such a way that the outer conductor is further deformed from the initial state and it becomes difficult to maintain a shape. With respect to this, like the present invention, since the winding body layer is disposed between the core line and the outer conductor, in comparison to a case of directly disposing an outer conductor near a core line, not only an effect of pressurizing the core line to the outer conductor due to sliding is decreased first but also the effect of pressurizing is further distributed by the winding body layer and accordingly the pressure to the outer conductor by the core line due to sliding may be decreased and a shape of the outer conductor may be maintained for a long time, for example, when a widthwise length of a member that forms the winding body layer is greater than that of the outer conductor.

Also, in the present invention, although the winding body layer is formed of ePTFE, it is based on a view of increasing stability in shape by reducing a change of a length with respect to curve of the cable caused by sliding by forming the winding body layer using a material having a small elongation rate.

Also, in the present invention, the inclusion is formed of polytetrafluoroethylene. However, it considers the elongation with respect to the curve caused by sliding. For example, when an inclusion is formed of rayon yarn as disclosed in the above-described second conventional example, an elongation rate thereof is from about 20% (a strong filament) to 40% (a general filament). In comparison thereto, when the inclusion is formed of polytetrafluoroethylene, an elongation rate thereof is very small from 4% (porous polytetrafluoroethylene (ePTFE)) to 12% (nonporous polytetrafluoroethylene (PTFE)) to provide a property of being hardly deformed by sliding. Due to this, a problem in which the inclusion does not function as a tension member of the cable and the completely elongated inclusion pushes another component upward in such a way that wrinkles are formed overall on the cable due to the elongation of the inclusion that occurs when the inclusion is formed of rayon yarn is reduced.

Also, in an embodiment, the winding body layer is formed of ePTFE and a material having a porosity rate from 40% to 75% is used. Accordingly, the above-described elongation rate is suppressed to be lower and stability in quality is secured.

Forming ellipticity of an overall cross-sectional shape of a cable of a new product to be within a range of 2 to 8% is not impossible when manufacturing conditions of the cable are pursued and is merely disregarded in an aspect of manufacturing costs until now. However, in the case of a cable manufactured costing as described to be close to a circular shape, ellipticity thereof immediately exceeds 10% only by repeating sliding or bending and quality thereof is not maintained for a long time. To maintain the ellipticity of the overall cross-sectional shape of the cable in the initial state to be within the range of 2 to 8%, it is necessary not to leave a sliding record of the cable and it becomes an absolute condition to use an inclusion of polytetrafluoroethylene. Accordingly, it is important to continuously form the winding body layer.

Also, in the present invention, it is viewed from a point of durability of shape-sustainability to set ellipticity after sliding (the number of sliding is ten thousand times) to be within a range of 2 to 10%. First, a reason of setting the upper limit of ellipticity to be 10% is as described above. First, since the ellipticity of the twisted pair cable increases with respect to uniformity of bending, a distance between the inner conductor and the outer conductor is irregular and fluctuation of a distance from a center of the inner conductor to the outer conductor in a longitudinal direction of the cable increases. Accordingly, characteristic impedance is scattered and reflection waves increase in such a way that an attenuation rate increases. The attenuation rate of the cable at a frequency of 900 MHz generally used for a camera link cable exceeds 10 dB and deterioration of electrical properties is shown.

With respect to this, setting the lower limit of ellipticity to be 2% is viewed from a point of flexibility as described above. Also, since flexibility is deteriorated by intensively winding a winding body layer and an outer conductor and accordingly an excessive compression force is applied, for example, even in an initial stage of slightly sliding, it may be apprehended that an inner conductor and a dielectric that form a core line are destructed and damaged and a standard deviation of characteristic impedance greatly excesses 3Ω in such a way that electrical properties are deteriorated.

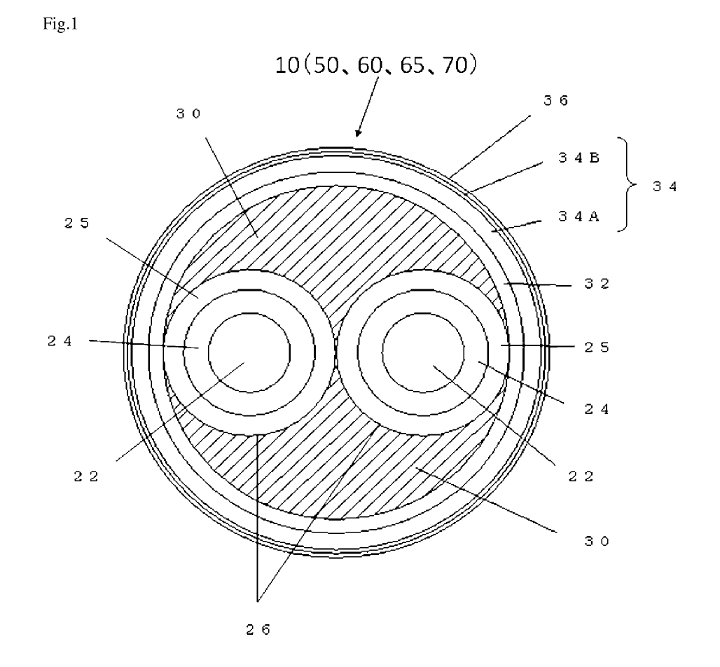

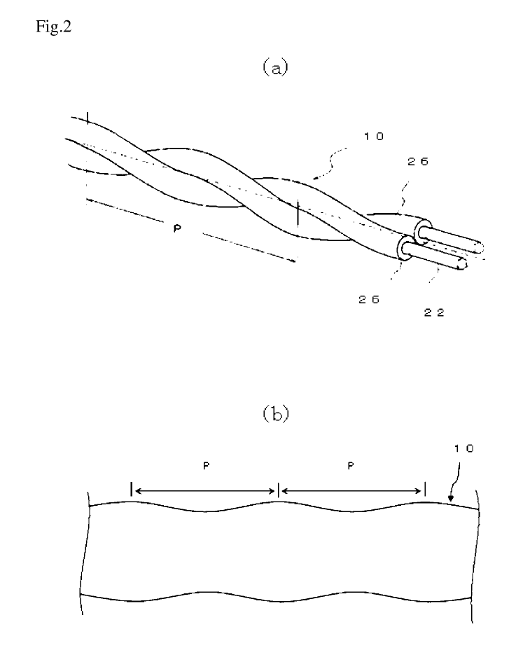

First, referring to FIGS. 1 and 2, twisted pair cables according to first to third embodiments of the present invention and a comparative example 1 will be described. FIG. 1 is a cross-sectional view illustrating a configuration of twin cables according to the first to third embodiments of the present invention and the comparative example 1. As shown in FIG. 1, a twisted pair cable 10 according to the first embodiment includes inner conductors 22 formed of a plurality of wires (19 wires in the first embodiment, not shown), two core lines (double-twisted core line) 26 and 26 including dielectric layers 24 and 25 having bi-level structures formed on outer circumferences thereof, an inclusion 30 twisted and combined with the two core lines 26 and 26, a winding body layer 32 wound on an outer circumference of the inclusion 30, an outer conductor 34 (34A and 34B) installed on an outer circumference of the winding body layer 32, and an outer coating (sheath) 36 installed on an outer circumference of the outer conductor 34. Here, the inner conductors 22 are formed of high-tensile silver-plated copper alloy lines, the dielectric layers 24 that are inner layers of the dielectric layers are formed of purple fluorinated ethylene propylene (hereinafter, referred to as FEP), and the dielectric layers 25 that are outer layers are formed of elongated porous polytetrafluoroethylene (hereinafter, referred to as ePTFE). Also, the inclusion 30 is formed of ePTFE having a porosity rate of 60% and formed in various filamentous shapes. The winding body layer 32 is formed of ePTFE having a porosity rate of 60%, has a tape shape having a predetermined width (5.5 mm), and is wound on the outer circumferences of the core lines 26 and the inclusion 30 while including the same. The outer conductor 34 is generally formed of a lateral lay shield 34A formed of tin-plated stannous copper alloy line (φ0.08 mm). Also, a tape-shaped aluminum foil-attached polyester tape (ALPET) that becomes a winding body layer 34B is wound on an outer circumference of the lateral lay shield 34A while an aluminum layer is disposed inside, and the winding body layer 34B also forms a part of the outer conductor 34. The outer coating 36 is formed of polyester.

Next, a method of manufacturing the high speed differential cable 10 according to the first embodiment will be described. The above-configured high speed differential cable 10 includes the dielectric layers 24 that become inner layers by removing FEP and coating the outer circumferences of the inner conductors 22. Next, tape-shaped ePTFE is wound on outer circumferences of the dielectric layers 24, the dielectric layers 25 that become outer layers are formed, and the core lines 26 including the inner conductors 22 and the dielectric layers 24 and 25 are formed. Next, two of the core lines 26 are prepared and additionally two inclusion bundles formed of a plurality of filamentous inclusion wires that become the inclusion 30 are prepared. The above-prepared two core lines 26 and 26 and two inclusion bundles are alternately arranged and twisting pitches P (refer to FIG. 2(a)) between convex parts of the core lines 26 spirally curved are twisted and combined at intervals of 12 mm that is 15 times of a diameter of a layer core by using a twisting machine.

FIG. 2(a) is a view illustrating only the two core lines 26 and 26 of the twisted pair cable 10 according to the first embodiment for convenience. Also, FIG. 2(b) is a view illustrating an uneven configuration of a surface shape that has a waveform in a longitudinal direction of the outer coating 36 in the twisted pair cable 10 according to the first embodiment. As shown in FIG. 2(b), unevenness caused by the above-described twisting pitch P of the core lines 26 and 26 and the inclusion 30 is formed on the surface in the longitudinal direction of the differential transmission cable 10 according to the first embodiment. This is because the twisting pitch P of the two core lines 26 shown in FIG. 2(b) influences surface shapes of the winding body layer 32 disposed on the outer circumferences of the core lines 26, the outer conductor 34, and the outer coating 36 and unevenness in a waveform is formed on an overall surface shape of the differential transmission cable 10.

Next, tape-shaped ePTFE is wound on the outer circumference of the core lines 26 and 26 and the inclusion 30 which are twisted and combined as described above (forming the winding body layer 32) and then a plurality of conductors are laterally wound (forming the lateral lay shield 34A). Since the winding body layer 32 is formed between the dielectric layers 25 and the lateral lay shield 34A that is the outer conductor as described above, the winding body layer 32 having a greater width than that of the linear lateral lay shield 34A pressurizes the core lines 26 and the inclusion 30 with a larger contact surface than that in a width direction. Accordingly, in comparison to a case without the winding body layer 32 as in a following comparative example 2, mutual position changes between the core lines 26 and the inclusion 30 caused by bending or sliding are suppressed, a cross-sectional shape of the twisted pair cable 10 is maintained, and a change in ellipticity of the cable is reduced.

Next, the winding body layer 34B is wound on the outer circumference of the lateral lay shield 34A while an aluminum layer is disposed inside. Lastly, the twisted pair cable 10 is formed by removing polyester from an outer circumference of the winding body layer 34B and forming a sheath (the outer coating 36). The twisted pair cable 10 formed as described above has unevenness formed on the surface of the outer coating 36 due to the twisting pitch P of the core lines 26 spirally curved by twisting and combining the above-described two core lines 26 and 26 and the inclusion 30 (refer to FIG. 2(b)). In the first embodiment, like the twisting pitch P of the core lines 26, a pitch of 12 mm is formed between convex parts of the outer coating 36. This is a value corresponding to 15 times of a diameter of a layer core.

The ellipticity of the initial state of the twisted pair cable 10 according to the first embodiment manufactured as described will be described. First, ellipticity f (%) is obtained by ((maximum value of diameter−minimum value of diameter)/(maximum value of diameter)×100) and refers to a value obtained by dividing R of a value obtained by subtracting a minimum value r of a diameter of the overall cross-sectional shape of the twisted pair cable 10 from a maximum value R of the diameter of the overall cross-sectional shape of the cable 10 and subsequent multiplication by 100. Ellipticity is measured at 30 places of a random cross section and an average thereof is calculated. In the below, ellipticity of [symbol] initial state [symbol] and [symbol] state after sliding [symbol] of the twisted pair cable 10 according to the first embodiment is shown in Table 1.

TABLE 1

| | Comparative | First | Second | Fourth | Third | Comparative | Comparative |
|---|---|---|---|---|---|---|---|
| | example 2 | embodiment | embodiment | embodiment | embodiment | example 1 | example 3 |
| Elongation | 5 | 5 | 5 | 11 | 5 | 5 | 22 |
| rate of | | | | | | | |
| inclusion (%) | | | | | | | |
| Ellipticity | 1.0 | 2.1 | 4.7 | 4.9 | 5.9 | 10.3 | 9.3 |
| (initial | | | | | | | |
| state) (%) | | | | | | | |
| Ellipticity | 1.8 | 2.7 | 5.6 | 6.8 | 7.3 | 13.2 | 14.5 |
| (after | | | | | | | |
| sliding) (%) | | | | | | | |

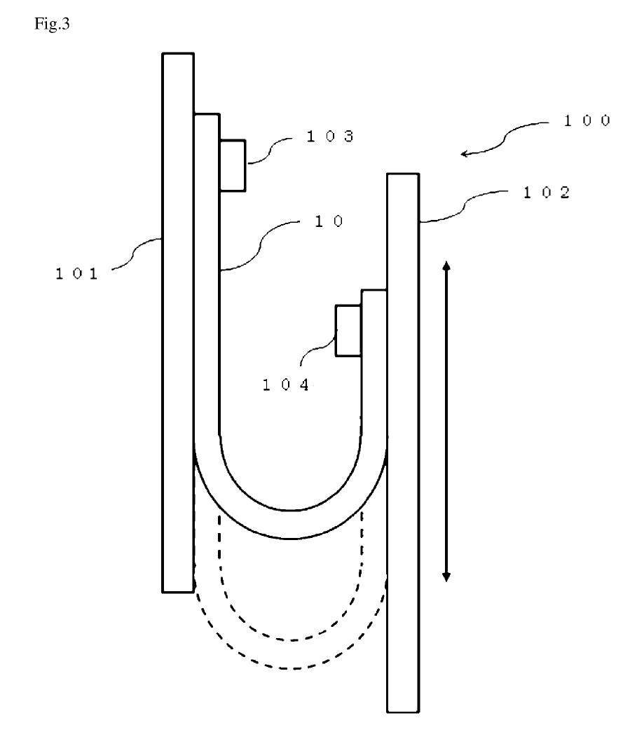

Here, the [symbol] initial state [symbol] and [symbol] state after sliding [symbol] will be described. The [symbol] initial state [symbol] of ellipticity refers to a state in which the twisted pair cable 10 manufactured with the above-described manufacturing conditions is slid 30 times by a sliding tester 100 schematically shown in FIG. 3. As shown in the same drawing, the sliding tester 100 includes a fixed plate 101 that vertically extends, a mobile plate 102 that vertically extends at a certain interval from the fixed plate 101 and reciprocally movable in a vertical direction, and pushing plates 103 and 104 in contact with both the plates 101 and 102 to fix both ends of a sample disposed between the fixed plate 101 and the mobile plate 102. As shown in the same drawing, using the sliding tester 100 configured as described above, the both ends are fixed to the fixed plate 101 and the mobile plate 102 using the pushing plates 103 and 104 in a state in which the twisted pair cable 10 with a sample length of 1 m is curved in a U shape (bending R=10 mm). Afterward, the mobile plate 102 reciprocates a predetermined number of times while a stroke length is 200 mm A state in which the mobile plate 102 is slid 30 times using the sliding tester 100 is referred to as the [symbol] initial state [symbol] (hereinafter, the same as in other embodiments). Also, the above-described [symbol] state after sliding [symbol] refers to a state in which the mobile plate 102 is slid ten thousand times using the sliding tester 100.

As shown in Table 1, the ellipticity of the initial state in the first embodiment is 2.1% and the ellipticity in the state after sliding is 2.7%.

Next, a second embodiment will be described. In a twisted pair cable 50 according to the second embodiment, in comparison to the above-described twisted pair cable 10 according to the first embodiment, a twisting pitch P of the core lines 26 and 26 and the inclusion 30 and ellipticity on the basis thereof are different and other components are same. In the second embodiment, the twisting pitch P is formed by twisting and combining by 17 mm that is 22 times of a diameter of a layer core. According thereto, as shown in Table 1, ellipticity is 4.7% in an initial state and is 5.6% in a state after sliding.

Next, a third embodiment will be described. In a twisted pair cable 60 according to the third embodiment, like the above-described second embodiment, in comparison to the above-described twisted pair cable 10 according to the first embodiment, a twisting pitch P of the core lines 26 and 26 and the inclusion 30 and ellipticity on the basis thereof are different and other components are same. In the third embodiment, the twisting pitch P is formed by twisting and combining by 40 mm that is 50 times of a diameter of a layer core. According thereto, as shown in Table 1, ellipticity is 5.9% in an initial state and is 7.3% in a state after sliding.

Next, a fourth embodiment will be described. In a twisted pair cable 65 according to the fourth embodiment, in comparison to the twisted pair cable 10 according to the first embodiment, a material of an inclusion and ellipticity are different and other components are same. In the fourth embodiment, the inclusion is formed of polytetrafluoroethylene (PTFE) and is configured in a plurality of filamentous shapes. As shown in Table 1, ellipticity is 4.9% in an initial state and is 6.8% in a state after sliding.

Next, a comparative example 1 will be described. In a twisted pair cable 70 according to the comparative example 1, like the above-described second and third embodiments, in comparison to the above-described twisted pair cable 10 according to the first embodiment, a twisting pitch P of the core lines 26 and 26 and the inclusion 30 and ellipticity on the basis thereof are different and other components are same. In the comparative example 1, a twisting pitch is formed by twisting and combining by 8 mm that is 10 times of a diameter of a layer core. According thereto, as shown in Table 1, ellipticity is 1.5% in an initial state and is 1.8% in a state after sliding.

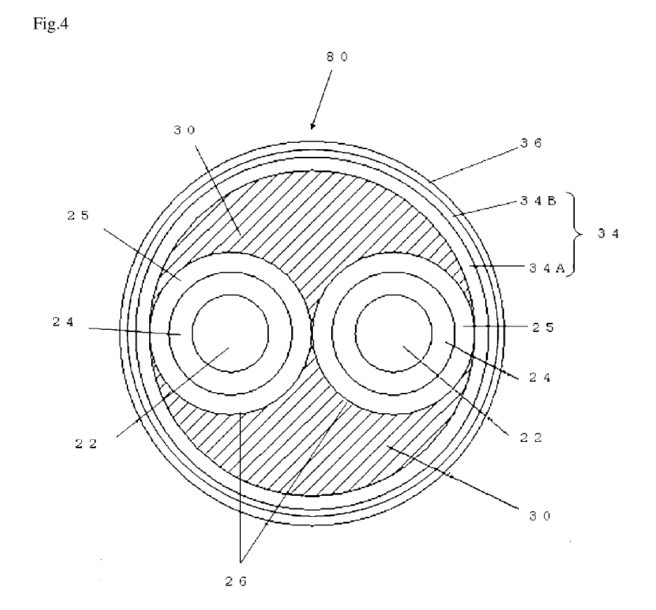

Next, a comparative example 2 will be described with reference to FIG. 4. As shown in the same drawing, in a twisted pair cable 80 according to the comparative example 2, in comparison to the first to third embodiments and the comparative example 1, the winding body layer 32 disposed between the dielectric layers 24 and 25 and the outer conductor 34 is not present and the outer conductor 34 is directly disposed on an outer circumference of the dielectric layers 25 and additionally a twisting pitch P of the core lines 26 and 26 and the inclusion 30 and ellipticity on the basis thereof are different and other components are same. In the comparative example 2, the twisting pitch P is formed by twisting and combining by 17 mm that is 22 times of a diameter of a layer core. According to the configuration, since there is a structure of directly winding a lateral lay shield from tops of the core lines 26 and 26 and the inclusion 30, due to a difference in flexibility between the core lines 26 and 26 and the inclusion 30, a deformation caused by a compression force of the lateral lay shield is irregular and it is difficult to maintain an original shape. Also, there is a gap between ellipticity and a desirable value and additionally a bending stress caused by sliding directly influences the lateral lay shield even when the lateral lay shield is put thereon. Accordingly, the lateral lay shield 34A is scattered and ellipticity more greatly fluctuates in a state after sliding. As a result thereof, as shown in Table 1, ellipticity is 10.3% in an initial state and is 13.2% in the state after sliding.

Next, a comparative example 3 will be described. In a twisted pair cable (not shown) according to the comparative example 3, in comparison to the twisted pair cable 10 according to the first embodiment, a material of an inclusion is changed to rayon yarn and other components are same. In the comparative example 3, a twisting pitch is formed by twisting and combining by 8 mm that is 10 times of a diameter of a layer core. According thereto, as shown in Table 1, ellipticity is 9.3% in an initial state and is 14.5% in a state after sliding.

Next, whether there is present uniformity in bending of the twisted pair cables on the basis of the ellipticity of the above first to fourth embodiments and comparative examples 1 to 3 will be described. As described above, the ellipticity increases in an order of the comparative example 1, the first embodiment, the second embodiment, the fourth embodiment, the third embodiment, the comparative example 3, and the comparative example 2. In a state in which the ellipticity further increases, in a distance between the inner conductors 22 that form the core lines 26 and the outer conductor 34, in comparison to a state in which ellipticity is 0%, since a deviation is formed in bending property in a bending direction of the cable and the bending property is deteriorated depending on the bending direction of the cable in a state in which any sliding is applied as shown as an initial state. In this state, it is checked that a reflection attenuation rate is further deteriorated. Receiving a result thereof, an attenuation rate of each cable in an initial state is shown in Table 2.

TABLE 2

| | Comparative | First | Second | Fourth | Third | Comparative | Comparative |
|---|---|---|---|---|---|---|---|
| | example 2 | embodiment | embodiment | embodiment | embodiment | example 1 | example 3 |
| Elongation | 5 | 5 | 5 | 11 | 5 | 5 | 22 |
| rate of | | | | | | | |
| inclusion (%) | | | | | | | |
| Ellipticity | 1.0 | 2.1 | 4.7 | 4.9 | 5.9 | 10.3 | 9.3 |
| (initial | | | | | | | |
| state) (%) | | | | | | | |
| Ellipticity | 1.8 | 2.7 | 5.6 | 6.8 | 7.3 | 13.2 | 14.5 |
| (state after | | | | | | | |
| sliding) (%) | | | | | | | |
| ellipticity (dB) | 8.5 | 8.7 | 9.7 | 9.8 | 9.8 | 35.1 | 42.3 |

Next, whether there is present flexibility of the twisted pair cables on the basis of the ellipticity of the first to fourth embodiments and comparative examples 1 to 3 will be described. As described above, the ellipticity decreases in an order of the comparative example 2, the comparative example 3, the third embodiment, the second embodiment, the fourth embodiment, the first embodiment, and the comparative example 1. In this state, as shown in Table 1, as the ellipticity further decreases, a more winding pressure of the outer conductor 34A laterally wound is applied for each unit length in a longitudinal direction of the core lines 26 increase. Also, since the two core lines 26 and 26 are twisted and combined with each other by a predetermined pitch and curved between the pitches to be spirally formed, the surfaces thereof are changed to uneven shapes. According thereto, a space between concave parts of the core lines 26 and 26 is compressed and additionally a space between convex parts elongates and tension is applied. The tension further increases as the twisting pitch further increases. When the cable is further bent from this state of the concave parts and the convex parts, they intensify due to a bending direction and a greater wrinkle is formed between valleys of the pitch and greater tension is applied between crests. Due to repeated bending, electrical properties thereof are gradually decreased. In this state, it is not necessarily to determine the ellipticity of 0% to be an adequate state and it is checked that electrical properties are deteriorated according to a decrease of flexibility. Receiving a result thereof, characteristic impedance of each cable in an initial state is shown in Table 3.

TABLE 3

| | Comparative | First | Second | Fourth | Third | Comparative | Comparative |
|---|---|---|---|---|---|---|---|
| | example 2 | embodiment | embodiment | embodiment | embodiment | example 1 | example 3 |
| Elongation | 5 | 5 | 5 | 11 | 5 | 5 | 22 |
| rate of | | | | | | | |
| inclusion (%) | | | | | | | |
| Ellipticity | 1.0 | 2.1 | 4.7 | 4.9 | 5.9 | 10.3 | 9.3 |
| (initial | | | | | | | |
| state) (%) | | | | | | | |
| Ellipticity | 1.8 | 2.7 | 5.6 | 6.8 | 7.3 | 13.2 | 14.5 |
| (state after | | | | | | | |
| sliding) (%) | | | | | | | |
| Characteristic | 0.305 | 0.179 | 0.159 | 0.192 | 0.151 | 0.144 | 0.141 |
| impedance (3Ω) | | | | | | | |

As described above, in the first to fourth embodiments, ellipticity is set to be within a range of 2 to 8% in the initial state of the twisted pair cable and to be within a range of 2 to 10% in the state after sliding. With respect to this, in the comparative examples 1 to 3, ellipticity beyond the upper limit and the lower limit of the ranges is compared. On the basis of the above, it is checked that uniformity in bending and flexibility are compatible only in the first to fourth embodiments and the effects thereof are achieved only within the ranges.

Also, in the embodiments, ePTFE or PTFE is applied as the material of the inclusion. With respect to this, for example, when rayon yarn is applied as an inclusion to the cable according to the second conventional example (refer to Patent document 2), since an elongation rate (20%) of the material is relatively great, the inclusion elongates due to even slight bending and sliding operations of the cable, moves from a position when being manufactured and pressurizes inner and outer members. Accordingly, it is apprehended that ellipticity of the entire cable is changed by deforming other members. With respect to this, in the embodiments, since ePTFE or PTFE is applied as the material of the inclusion as described above, an elongation rate is small as 4% and there is less influence on the ellipticity of the cable. As described above, in the embodiments, since the cable includes members having less change in ellipticity even due to bending and sliding operations, it is difficult that a change occurs in ellipticity of the cable after the operations and thus it is possible to increase stability in quality.

Also, since the lateral lay shield (the outer conductor 34) is formed using the inclusion and the winding body layer 32 that becomes the winding body layer in addition to applying of the material having a small elongation rate, in comparison to the case of the lateral lay shield having a linear shape, the tape-shaped winding body layer 32 having a tape shape having a uniform width pushes the inclusion and the double-twisted core line at a greater surface in such a way that a relative change in positions of the inclusion and the double-twisted core line is reduced and it is possible to precisely adjust ellipticity while manufacturing the cable and additionally to increase stability of quality of the cable.

Also, all the cables described in the first to third embodiments are configured to have the twisting pitch P within a range of 15 times to 50 times of a diameter of a layer core and accordingly a length of a width between crests of unevenness of a waveform of the surface shape in a longitudinal direction of the outer coating 36 is also within the range of 15 times to 50 times of the diameter of the layer core. Due to the above configuration, the twisting pitch P further decreases in such a way that an adhesive force between the core lines 26 and 26 and the inclusion 30 increases. Accordingly, since it is adjusted to be within a range of preventing flexibility from being deteriorated with respect to bending, it is possible to surely provide a cable having improved stability in quality. Also, when the twisting pitch P is formed less than 15 times of the diameter of the layer core (for example, in the comparative example 2), it is impossible to provide flexibility as described above. Also, when the twisting pitch P is formed greater than 50 times of the diameter of the layer core, the pitch excessively increases in such a way that the core lines and the inclusion are easily released, it is impossible to maintain a twisted state, and it is difficult to manufacture the cable itself.

### DESCRIPTION OF REFERENCE NUMERALS

10: Differential transmission cable
22: Inner conductor
24: Dielectric layer (inner layer)
25: Dielectric layer (outer layer)
26: Core line
28: Double-twisted core line
30: Inclusion
32: Winding body layer
34: Outer conductor
34A: Lateral lay shield
34B: Winding body layer (ALPET)
36: Outer coating
50: Differential transmission cable
60: Differential transmission cable

### INDUSTRIAL APPLICABILITY

The present invention is generally applicable to any cable configured to include a double-twisted core line formed by twisting two core lines having conductors and dielectric layers formed on outer circumferences thereof, an inclusion formed of polytetrafluoroethylene and twisted and combined with the double-twisted core line, a winding body layer wound on an outer circumference of the core lines and the inclusion, an outer conductor installed on an outer circumference of the winding body layer, and an outer coating installed on an outer circumference of the outer conductor and formed to have ellipticity of an overall cross-sectional shape of the cable to be within a range of 2% to 8%, regardless of size, material, and use thereof. That is, it is also applicable not only to a cable used for an image test in a line of a plant but also to a cable used for peripheral devices of a PC or a television such a USB cable and the like.

1. A twisted pair cable comprising:
a double-twisted core line formed by twisting two core lines having conductors and dielectric layers formed on outer circumferences thereof;
an inclusion formed of polytetrafluoroethylene and twisted and combined with the double-twisted core line;
a winding body layer wound on an outer circumference of the core lines and the inclusion;
an outer conductor installed on an outer circumference of the winding body layer; and
an outer coating installed on an outer circumference of the outer conductor,
wherein ellipticity of an overall cross-sectional shape of the cable in an initial state is formed to be within a range of 2% to 8%.

2. The twisted pair cable of claim 1, wherein a length of a width between crests of unevenness of a waveform of a surface shape in a longitudinal direction of the outer coating is 15 times to 50 times of a diameter of the core line.

3. A twisted pair cable comprising:
a double-twisted core line formed by twisting two core lines having conductors and dielectric layers formed on outer circumferences thereof;
an inclusion formed of polytetrafluoroethylene and twisted and combined with the double-twisted core line;
a winding body layer wound on an outer circumference of the core lines and the inclusion;
an outer conductor installed on an outer circumference of the winding body layer; and
an outer coating installed on an outer circumference of the outer conductor,
wherein ellipticity of an overall cross-sectional shape of the cable in a state after a predetermined sliding test is formed to be within a range of 2% to 10%.
